(19) United States
(12) Patent Application Publication
(10) Pub. No.: US 2009/0003332 A1
(43) Pub. Date: Jan. 1, 2009

(54) GEOLOCATION TECHNIQUE ASSOCIATED WITH WIRELESS COMMUNICATIONS

(76) Inventors: Michael J. Flanagan, Chester, NJ (US); Andrew K. Mackay, Wellington (NZ); Daksh Sadarangani, Wellington (NZ)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/770,971

(22) Filed: Jun. 29, 2007

(51) Int. Cl. H04L 12/56

(52) U.S. Cl. 370/389

(57) ABSTRACT

A geolocation technique for determining a location of a mobile station includes using network information regarding a wireless communication event between the mobile station and a wireless communication network. A plurality of other wireless communication events are instigated to generate additional call records including the network information that is useful for a location determination. At least some of the plurality of call records are used with a geolocation algorithm for making a determination regarding a location of the mobile station. One example includes using a voice call, data call or short-message-service (SMS) call for at least one or all of the other wireless communication events.

### FIELD OF THE INVENTION

This invention generally relates to communication. More particularly, this invention relates to wireless communications and geolocation.

### DESCRIPTION OF THE RELATED ART

Wireless communications are well known and in widespread use. Typical systems include a wireless network that allows a mobile station (e.g., a cell phone, notebook computer or personal digital assistant) to conduct communications with another remotely located device. The mobile station typically makes contact over a wireless link with a base station transceiver that is associated with the wireless communication network. The signal transmissions between the mobile station and the base station can provide information that is useful for determining a location of the mobile station.

There are various situations in which a mobile station location is required or desired. When a mobile station is used to place an emergency services call (e.g., a 911 or a 112 call), it is necessary to determine where the mobile station is located to dispatch the appropriate response personnel. Another situation where mobile station location information is useful is when a mobile subscriber desires to obtain information regarding the local vicinity and would like to receive such information at the mobile station. The location is necessary for providing relevant information to a subscriber in such a situation.

One proposal for locating a mobile station includes using network information regarding a single event such as a voice call, data call or a single short-message-service (SMS) call. There is known network information that is generated as the result of such an event that can provide information for locating a mobile station. The difficulties with this approach is that the network information associated with such a single event is often not available until after the event has been completed (e.g., the call is terminated). Further, the network information associated with a single call often is corrupted by noise or propagation effects, which limits the accuracy of a resulting geolocation determination, and being a single data point there is no way of stating the likely error bands of the determination.

It would be useful to be able to accurately locate a mobile station based upon network information that is available as a result of a communication event between a mobile station and a wireless communication network.

### SUMMARY

An exemplary method of locating a mobile station includes conducting a first wireless communication event between the mobile station and a network. A plurality of other wireless communication events are instigated between the mobile station and the network within a selected time of the first wireless communication event. A location of the mobile station is determined from network information regarding the first event and at least some of the plurality of other wireless communication events.

Utilizing a plurality of wireless communication events and the associated network information allows for more accurately locating a mobile station. The increased amount of network information associated with multiple wireless communication events allows for improved location accuracy because noise contributions from any of the events can be mitigated using noise filtering, for example.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication arrangement that is useful with an embodiment of this invention.

FIG. 2 is a flowchart diagram summarizing one example approach.

### DETAILED DESCRIPTION

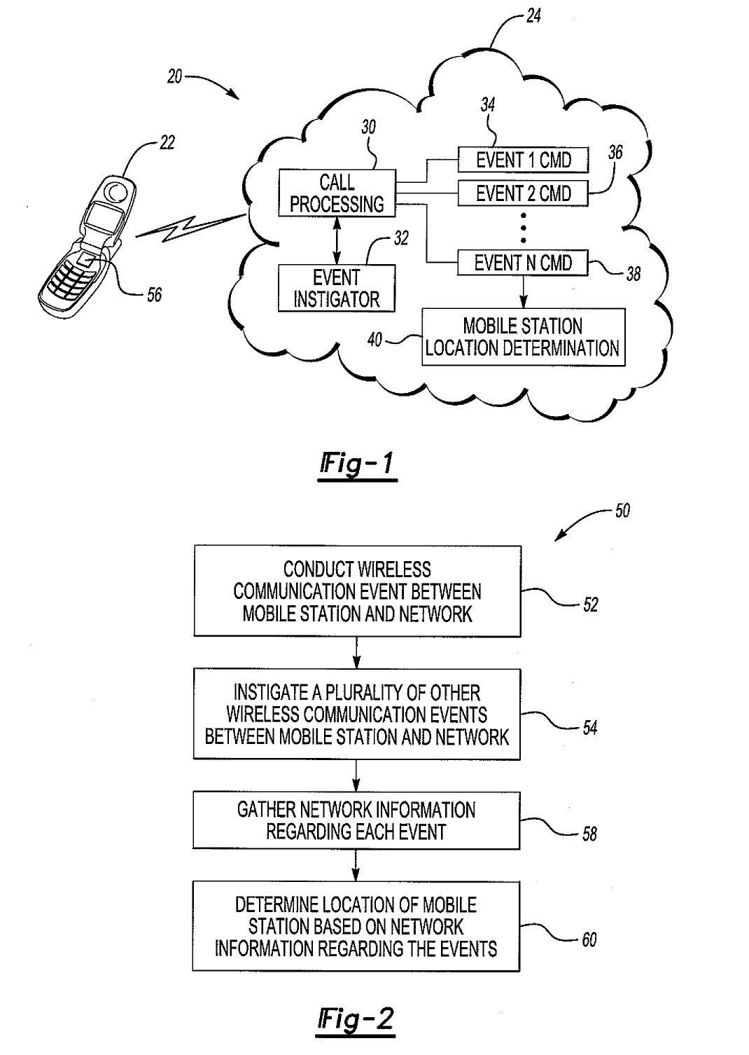

FIG. 1 shows a wireless communication arrangement 20 including a mobile station 22 and a wireless communication network 24. The mobile station 22 conducts wireless communications over radio frequency links between the mobile station 22 and appropriate portions of the network 24 such as base station transceivers that operate in a generally known manner. The configuration of a wireless network and base station transceivers is known and, therefore, only selected portions of the example network 24 are shown for illustration and discussion purposes.

In some instances, it will be useful to determine the location of the mobile station 22. With the illustrated example, network information that is generated by a call processing portion 30 of the network 24 is used for location purposes. For example, when the mobile station 22 is used for a voice call, a data call or a short-message-service (SMS) call (e.g., text messaging), the call processing portion 30 generates call detail records (CDR) and per call measurement data (PCMD). The call processing portion 30 in one example uses known techniques for generating such a call record regarding each wireless communication event (e.g., call) involving the mobile station 22 and the network 24.

Example types of call record information include an identification of the cell that is involved in servicing the mobile station 22, an identification of the sector that is involved in servicing the mobile station 22, timing information such as round trip delay for all links of the radio channel used during the event, mobile station identity information, an indication of the type of service used during the event, an indication of the number that was dialed, an indication of the time length of the call, an indication of signal strengths associated with the event and an indication of timing associated with signal transmissions between the mobile station 22 and the network 24. Such information or selected portions of such information can be used for making a determination regarding the location of the mobile station 22. There are known techniques for taking such network information and estimating a location of a mobile station. One example implementation of this invention uses such a known technique.

The example of FIG. 1 includes an event instigator 32 that is part of the network 24. The event instigator 32 instigates a plurality of additional wireless communication events within a selected time of a single wireless communication event between the mobile station 22 and the network 24. Each additional event results in its own set of network information generated by the call processing portion 30. Instigating a plurality of other wireless communication events between the mobile station 22 and the network 24 facilitates generating a plurality of call records as schematically shown at 34, 36 and 38. Each one of these call records includes the type of information described above (i.e., timing information that is useful for a distance determination) that can be used for determining the location of the mobile station 22. Instigating a plurality of additional wireless communication events within a selected time of a given wireless communication event (e.g., a call requesting emergency services) provides additional network information that is useful for making the location determination.

The example of FIG. 1 includes a mobile station location determination portion 40 that is associated with the network 24 for making a determination based upon at least selected portions of the call records 34, 36 and 38. Having a cluster of call or event records each with its own measurements that are useful for location determinations allows for filtering out errors such as noise in a geolocation algorithm because multiple call records are available for analysis. Utilizing the respective call records for at least some of a plurality of wireless communication events for a single mobile location determination provides significantly improved accuracy compared to relying upon the network information from only a single wireless communication event.

For a voice call, for example, the type of network information that is useful for a possible location determination is written by the network at the end of the call. A single event call record may include only two round trip delay records with one of them being associated with the call setup and the other being associated with a time just before the call was completed. If only one wireless communication event is utilized, there is limited information and there is the possibility of noise or errors in that information. By instigating a plurality of other wireless communication events and then using the respective call records for at least some of those events to make the location determination, the illustrated example provides significantly improved accuracy and reliability.

The flowchart diagram 50 of FIG. 2 summarizes one example approach. At 52, a wireless communication event is conducted between the mobile station and the network. This event may occur in a known manner for many example circumstances. At 54, a plurality of other wireless communication events are instigated between the mobile station and the network. In one example, the event instigator 32 is responsible for instigating each of the other wireless communication events. In one example, SMS calls are used because they can provide network information for generating a call record without requiring any response by the user of the mobile station 22. Additionally, SMS messages can be sent to a mobile station even when it is involved in another call. Each SMS message event generates network information that can be used for the location determination. Other examples include instigating at least one other voice call or at least one other data call between the mobile station 22 and the network 24.

In one example, the event instigator 32 is programmed to determine when additional wireless communication events would be useful for a location determination. For example, the call processing portion 30 may recognize when a call requesting emergency services has been placed by a user of a mobile station. The call processing portion 30 then provides information to the event instigator 32 so that the additional wireless communication events occur to provide the additional call records for location determination. In another example, the call processing portion 30 determines that the mobile station 22 has been used to place a request for information regarding a vicinity or area where the subscriber is located. In order to provide the requested information, it will be necessary to know where the mobile station is located if the user did not provide sufficient location information as part of the request. In such a scenario, the event instigator 32 responds by instigating a plurality of wireless communication events so that the associated call record information can be used for making a location determination.

In another example, the mobile station 22 includes an event instigator 56 that instigates a plurality of other wireless communication events. In one example, the event instigator 56 is programmed to recognize when the mobile station 22 is used to place an emergency service call. The event instigator 56 in one such example automatically generates a plurality of SMS messages and sends them from the mobile station 22 so that the network 24 generates a call record for each such event. In another example, the event instigator 56 is programmed to instigate a plurality of wireless communication events involving the mobile station 22 when the user takes some action with the mobile station 22 that indicates that the user wants or needs location information (e.g., the user would like to download a map of the local vicinity).

In some examples, the event instigator 32 and the event instigator 56 will both instigate other wireless communication events at an appropriate time to generate additional call records for each such event and provide additional information for making a location determination.

At 58, the network information regarding each event is gathered and used with a known location algorithm for making a location determination. The actual location determination is made in the example of FIG. 2 at 60.

In some examples, the plurality of other wireless communication events will not occur until after the first wireless communication event has been completed. In other examples, at least one of the plurality of other wireless communication events occurs while the first event is still ongoing. One example includes timing the plurality of other events so that a previous event is complete before the next one begins. Provided that there is a sufficiently limited amount of time between all of the events, their associated call records can provide useful location information. One advantage to using SMS calls as the other wireless communication events is that they can be automatically instigated and can occur in rapid succession so that a sufficient number of additional events provide a sufficient amount of network information for the location determination.

In one example, at least two other wireless communication events are used so that there are at least three call records with corresponding information useful for a location determination. One example includes up to six additional communication events so that there are a total of seven call records available for the location determination.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of locating a mobile station, comprising:
conducting a first wireless communication event between the mobile station and a network;
instigating a plurality of other wireless communication events between the mobile station and the network within a selected time of the first wireless communication event;
determining a location of the mobile station from network information regarding the first event and at least some of the plurality of other wireless communication events.

2. The method of claim 1, comprising
instigating the other wireless communication events responsive to determining that the first wireless communication event indicates that the location of the mobile station should be determined.

3. The method of claim 2, wherein the first event comprises a call from the mobile station for emergency services.

4. The method of claim 1, comprising
instigating at least one of the plurality of other events during the first event.

5. The method of claim 1, comprising
instigating the plurality of other events after the first event has ended.

6. The method of claim 1, wherein at least one of the wireless communication events comprises one of a voice call, a data call or a short message service communication.

7. The method of claim 1, wherein each of the plurality of other wireless communication events comprises a short message service communication.

8. The method of claim 1, comprising
establishing a call record regarding each event; and
wherein the network information comprises at least one feature of each call record.

9. The method of claim 8, wherein the network information comprises at least
an identifier of a cell within which each event occurred,
an identifier of a sector within which each event occurred and
timing information regarding signals used for the communication events.

10. The method of claim 9, wherein the timing information comprises round trip delay information regarding each link of a channel used for each event.

11. The method of claim 1, comprising
timing the plurality of other events such that the network information regarding each event pertains to the same location of the mobile station.

12. The method of claim 1, comprising
selecting a wireless communication event for at least one of the plurality of other events that can be successfully received by the mobile station even if the mobile station is currently involved with another wireless communication.

13. The method of claim 1, comprising
timing the plurality of other events such that each of the plurality of other events occurs after a previous one of the plurality of other events is complete.

14. The method of claim 1, wherein the plurality of other events includes between two and six events.

15. The method of claim 1, comprising
instigating the plurality of other events at the network.

16. The method of claim 1, comprising
instigating the plurality of other events at the mobile station.
